(19) United States
(12) Patent Application Publication
(10) Pub. No.: US 2023/0196745 A1
(43) Pub. Date: Jun. 22, 2023

(54) ADVERSARIAL ATTACK METHOD FOR MALFUNCTIONING OBJECT DETECTION MODEL WITH SUPER RESOLUTION

(71) Applicant: Korea University Research and Business Foundation, Seoul (KR)

(72) Inventors: Junbeom HUR, Yongin-si (KR); Minjae KIM, Seoul (KR); Gyeongsup LIM, Seoul (KR)

(73) Assignee: Korea University Research and Business Foundation, Seoul (KR)

(21) Appl. No.: 18/077,599

(22) Filed: Dec. 8, 2022

(30) Foreign Application Priority Data
Dec. 22, 2021 (KR) 10-2021-0184526

(51) Int. Cl. G06V 10/776; G06V 10/82; G06T 3/40

(52) U.S. Cl. CPC G06V 10/776; G06V 10/82; G06T 3/4046; G06T 3/4053

(57) ABSTRACT

Disclosed is a method for performing an adversarial attack by a computing device including one or more processors, which may include: generating a first conversion image by inputting an original image into a first neural network model; generating first object detection result data by inputting the first conversion image into a second neural network model; generating first noise based on a first loss value between the first object detection result data and a prestored ground-truth; generating a first adversarial image based on the first noise and the first conversion image; generating second noise based on a second loss value between the first adversarial image and the first conversion image; and generating a second adversarial image based on the second noise and the original image.

### CROSS-REFERENCE TO RELATED APPLICATIONS

This application claims priority to and the benefit of Korean Patent Application No. 10-2021-0184526 filed in the Korean Intellectual Property Office on Dec. 22, 2021, the entire contents of which are incorporated herein by reference.

### TECHNICAL FIELD

The present disclosure relates to an artificial intelligence technology, and more particularly, to an adversarial attack method for malfunctioning an object detection model with super resolution.

### BACKGROUND ART

An object detection model is an artificial intelligence model that specifies a location of an object in an image by using an artificial neural network, and conducts classification for the object among computer vision fields.

A super resolution model is an artificial intelligence model that generates an image which is similar as possible to an image quality of an original image, and has a larger resolution than the original image by using the artificial neural network.

Two models described above as a model combination which can be easily used for a combination of a digital zoom and object detection or for detecting a small object in a satellite photo has a high feasibility and is easily exposed to users in the computer vision fields. This also means that an influence of an adversarial attack against the combination of two models on an actual user may be fatal.

The adversarial attack generally means an attack that prevents a model to be attacked from driving an original normal result by adding noise which cannot be distinguished by a person to input data. Here, the input data to which the noise is added may be called an adversarial example. In addition, the adversarial attack against a computer vision model is made through an adversarial image generated by adding the noise to each pixel of the image at a predetermined level.

### SUMMARY OF THE INVENTION

The present disclosure has been made in an effort to provide an adversarial attack method for malfunctioning an object detection model with super resolution.

However, technical objects of the present disclosure are not restricted to the technical object mentioned above. Other unmentioned technical objects will be apparently appreciated by those skilled in the art by referencing to the following description.

An exemplary embodiment of the present disclosure provides a method for performing an adversarial attack by a computing device including one or more processors, which may include: generating a first conversion image by inputting an original image into a first neural network model; generating first object detection result data by inputting the first conversion image into a second neural network model; generating first noise based on a first loss value between the first object detection result data and a prestored ground-truth; generating a first adversarial image based on the first noise and the first conversion image; generating second noise based on a second loss value between the first adversarial image and the first conversion image; and generating a second adversarial image based on the second noise and the original image.

Alternatively, the first neural network model may include a first super resolution model that generates the first conversion image configured with a higher resolution than the original image based on the original image.

Alternatively, the second neural network model may include a first object detection model that detects at least one object in the first conversion image, and designates a location and a class of at least one object, and generates the first object detection result data.

Alternatively, the first neural network model may be pre-learned based on a predetermined first loss function, and the generating of the first noise based on the first loss value between the first object detection result data and the prestored ground-truth may include calculating the first loss value between the first object detection result data and the prestored ground-truth based on the predetermined first loss function, and generating the first noise based on the calculated first loss value.

Alternatively, the second neural network model may be pre-learned based on a predetermined second loss function, and the generating of the second noise based on the second loss value between the first adversarial image and the first conversion image may include calculating the second loss value between the first adversarial image and the first conversion image based on the predetermined second loss function, and generating the second noise based on the calculated second loss value.

Alternatively, the generating of the first adversarial image based on the first noise and the first conversion image may include generating the first adversarial image by adding the first noise to at least one first conversion image pixel constituting the first conversion image.

Alternatively, the generating of the second adversarial image based on the second noise and the original image may include generating the second adversarial image by adding the second noise to at least one original image pixel constituting the original image.

Alternatively, the method may further include determining a performance of the third neural network model by inputting the second adversarial image into a third neural network model.

Alternatively, in claim 8, the determining of the performance of the third neural network model by inputting the second adversarial image into the third neural network model may include generating second object detection result data by inputting the second adversarial image into the third neural network model, and determining the performance of the third neural network model based on a third loss value between the second object detection result data and the prestored ground-truth.

Alternatively, the third neural network model may be a model in which a second super resolution model of generating a second conversion image configured with a higher resolution than the second adversarial image based on the second adversarial image and a second object detection model of detecting at least one object in the second conversion image, and designating a location and a class of at least one detected object to generate the second object detection result data are combined.

Another exemplary embodiment of the present disclosure provides a non-transitory computer readable medium storing a computer program, in which the computer program comprises instructions for causing a processor of a computing device for performing an adversarial attack to perform the following steps, and the steps may include: generating a first conversion image by inputting an original image into a first neural network model; generating first object detection result data by inputting the first conversion image into a second neural network model; generating first noise based on a first loss value between the first object detection result data and a prestored ground-truth; generating a first adversarial image based on the first noise and the first conversion image; generating second noise based on a second loss value between the first adversarial image and the first conversion image; and generating a second adversarial image based on the second noise and the original image.

Still another exemplary embodiment of the present disclosure provides a computing device for performing an adversarial attack, which may include: a processor; a memory storing a computer program executable in the processor; and a network unit, and the processor may be configured to generate a first conversion image by inputting an original image into a first neural network model; generate first object detection result data by inputting the first conversion image into a second neural network model; generate first noise based on a first loss value between the first object detection result data and a prestored ground-truth; generate a first adversarial image based on the first noise and the first conversion image; generate second noise based on a second loss value between the first adversarial image and the first conversion image; and generate a second adversarial image based on the second noise and the original image.

According to an exemplary embodiment of the present disclosure, an adversarial attack for malfunctioning an object detection model with a super resolution can be performed.

According to an exemplary embodiment of the present disclosure, unlike an individual attack of performing an attack against only one conventional model, an attack against two models is performed to achieve a high performance.

According to an exemplary embodiment of the present disclosure, the adversarial attack against the object detection model with the super resolution is performed to measure robustness by evaluating the model.

According to an exemplary embodiment of the present disclosure, a vision of a research into a defense method of a computer vision model can be expanded.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a block diagram of a computing device for providing a method for performing an adversarial attack according to some exemplary embodiments of the present disclosure.

FIG. 2 is a schematic view illustrating a neural network model according to some exemplary embodiments of the present disclosure.

FIG. 3 is a block diagram of a processor of the computing device for describing the method for performing an adversarial attack according to some exemplary embodiments of the present disclosure.

FIG. 4 is a diagram for describing a first neural network model according to some exemplary embodiments of the present disclosure.

FIG. 5 is a diagram for describing a second neural network model according to some exemplary embodiments of the present disclosure.

FIG. 6 is a diagram for describing a third neural network model according to some exemplary embodiments of the present disclosure.

FIG. 7 is a flowchart for describing the method for performing an adversarial attack performed by the computing device according to some exemplary embodiments of the present disclosure.

FIG. 8 illustrates a simple and general schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled technicians may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

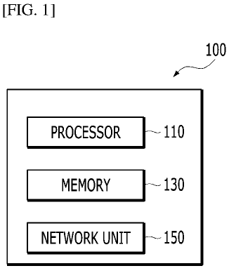

FIG. 1 is a block diagram of a computing device for providing a method for performing an adversarial attack according to some exemplary embodiments of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 according to some exemplary embodiments of the present disclosure may be a device for performing an adversarial attack. The adversarial attack may be an attack that prevents an input specific neural network model from deriving an original normal result by adding noise to input data.

The computing device 100 may generate an adversarial image by using neural network models to perform the adversarial attack. The adversarial image may be an image generate by adding the noise to each pixel of an image input into the specific neural network model.

The computing device 100 may determine a performance of a neural network model to be evaluated by using the adversarial image.

Meanwhile, the computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of a plurality of computing devices may be used together to process the learning of the network function and the data classification using the network function. Further, the computer program executed in the computing device according to an exemplary embodiment of the present disclosure may be a CPU, GPGPU, or TPU executable program.

According to some exemplary embodiments of the present disclosure, the memory 130 may store any type of information generated or determined by the processor 110 and any type of information received by the network unit 150.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

In respect to the network unit 150 according to some exemplary embodiments of the present disclosure, an arbitrary wired/wireless communication network which may transmit/receive an arbitrary type of data and signal may be included in the network expressed in the present disclosure.

The techniques described in this specification may also be used in other networks in addition to the aforementioned networks.

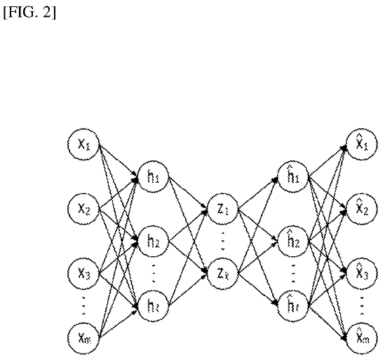

FIG. 2 is a schematic view illustrating a neural network model according to some exemplary embodiments of the present disclosure.

Throughout the present specification, a computation model, the neural network, a neural network model, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to still another exemplary embodiment of the present disclosure, the number of nodes of the input layer may be larger than the number of nodes of the output layer, and the neural network may be a neural network of a type in which the number of nodes increases from the input layer to the hidden layer. The neural network according to yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, restricted Boltzmann machine (RBM), a deep belief network (DBN), a Q network, a U network, a Siam network, a generative adversarial network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having the smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

Throughout the present specification, a computation model, the neural network, a neural network model, a network function, and the neural network may be used as the same meaning. Hereinafter, the computation model, the neural network, a neural network model, the network function, and the neural network will be integrated and described as the neural network. The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include weights of the neural network (weights and parameters may be used as the same meaning in the present disclosure). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

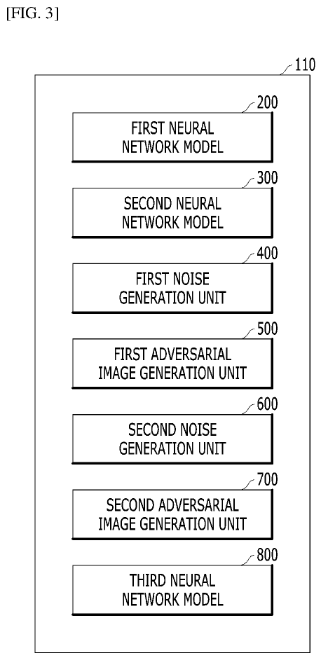

A configuration of the processor 110 for performing the adversarial attack by using the neural network model described through FIGS. 1 and 2 above will be described below with reference to FIG. 3.

FIG. 3 is a block diagram of a processor of the computing device for describing the method for performing an adversarial attack according to some exemplary embodiments of the present disclosure.

Referring to FIG. 3, the processor 110 of the computing device 100 may include a first neural network model 200, a second neural network model 300, a first noise generation unit 400, a first adversarial image generation unit 500, a second noise generation unit 600, a second adversarial image generation unit 700, and a third neural network model 800. However, components described above are not required in implementing the processor 110 and the processor 110 may thus have components more or less than components listed above.

An original image may be input into the first neural network model 200, which converts the input original image to generate a first conversion image. The first neural network model 200 may include a first super resolution model that generates the first conversion image configured with a higher resolution than the original image based on the original image.

The first neural network model 200 may include the first super resolution model that includes at least one of a Super-Resolution Convolutional Neural Network (SRCNN), a Residual channel attention network (RCAN), and/or a Deep Back-Projection Network (DBPN).

Here, the SRCNN may be a neural network model constituted by a plurality of layers (e.g., three layers). The SRCNN may be a neural network model that downsamples the original image by a bicubic scheme in a preprocessing step to generate a low-resolution image. In addition, the SRCNN may be previously learned by a scheme of learning a feature between an image which is not clear generated from the low-resolution image and the original image. The SRCNN may be a neural network model that generates the first conversion image configured with a higher resolution than the original image by using the input original image.

The RCAN may be a neural network model that extracts feature information of the original image through a convolutional layer. In addition, the RCAN may be a neural network model that extracts deep feature information from the feature information through a channel attention module to generate the first conversion image which is the high-resolution image.

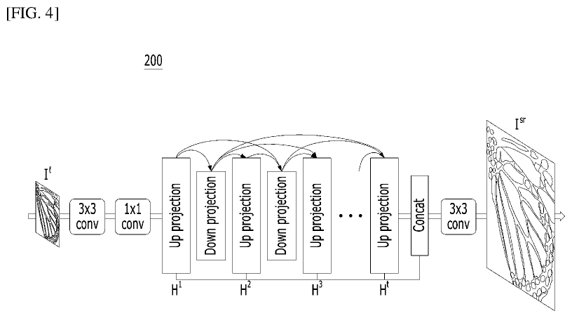

The DBPN will be described below with reference to FIG. 4. FIG. 4 is a diagram for describing a first neural network model according to some exemplary embodiments of the present disclosure.

Referring to FIG. 4, the DBPN may be a neural network model that extracts a feature map by inputting an original image I^{l} into convolutional layers, and inputs the feature map into a module in which an up-block and a down-block are repeatedly configured. The up-block may be a block that enlarges the feature map. The down-block may be a block that reduces the feature map. An error of each of the up-block and the down-block repeatedly configured is calculated to deliver a feedback to the network. In addition, the DBPN may be a neural network model that concatenates enlarged respective feature maps H¹ to H^{t} generated in the up-blocks, respectively. The DBPN may be a neural network model that generates a first conversion image I^{sr} which is the high-resolution image by inputting the concatenated enlarged feature map into the convolutional layer.

Meanwhile, the first neural network model 200 may be pre-learned based on a predetermined first loss function. The first loss function may be a criterion for determining a similarity degree between a prediction value and an actual value. The first loss function may include at least one of a mean squared error, a mean absolute error, and/or a root mean square error.

The mean squared error may be a mean value acquired by squaring a mean between the prediction value and the actual value.

The mean absolute error may be a mean value acquired by converting a difference value between the prediction value and the actual value into an absolute value, and adding the converted difference values, and dividing the added converted difference values by the number of difference values.

The root mean square error may be a value acquired by putting a root on the mean squared error. Therefore, the root mean square error may reduce distortion which occurs through a square in the mean squared error, and represent the error more intuitively. Meanwhile, the predetermined first loss function may be expressed by Equation 1 below.

(outputᵢ−targetᵢ)² [Equation 1]

Here, i may represent a pixel number (e.g., in the case of an image having a resolution of 300*300, i is a number from 1 to 90000), output may represent each pixel of the first conversion image, and target may represent the original image or each pixel of the first adversarial image. The first adversarial image may be an image generated by the first adversarial image generation unit 500. A detailed description of the first adversarial image will be described below when the first adversarial image generation unit 500 is described.

Referring back to FIG. 3, the first conversion image may be input into the second neural network model 300, which may generate first object detection result data based on the first conversion image. The second neural network model 300 may include a first object detection model that detects at least one object in the first conversion image, and designates a location and a class of at least one object, and generates the first object detection result data.

The second neural network model 300 may include the first object detection model including at least one of You Only Look Once (YOLO), Region-based Convolutional Neural Networks (Faster R-CNN), and/or Single Shot Multibox Detector (SSD).

Here, the YOLO may be an algorithm that divides the first conversion image into a plurality of grids having the same size. The YOLO may be an algorithm that predicts the number of bounding boxes designed in a predefined form around a grid center for each of the plurality of grids. The YOLO may be an algorithm that calculates the reliability based on the number of bounding boxes, and selects a location having a high object reliability by considering whether the object is included in the image and identifies the object. The YOLO may be an algorithm that designates the class of the identified object to generate the first object detection result data.

The Faster R-CNN may be a neural network model that extracts the feature map from the first conversion image through the CNN, and generates object area candidates through the feature map by using Region Proposal Net (RPN). The Faster R-CNN may be a neural network model that calculates coordinates and scores of the object area candidates, and designates the class of the object based on the score to generate the first object detection result data.

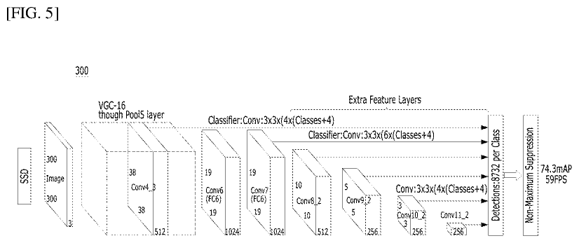

The SSD will be described below with reference to FIG. 5. FIG. 5 is a diagram for describing a second neural network model according to some exemplary embodiments of the present disclosure.

Referring to FIG. 5, the SSD may be a neural network model that extracts the feature map from the first conversion image through the CNN. The SSD may be a neural network model that extracts a plurality of feature maps having various sizes by using a plurality of different convolutional layers. The SSD may be a neural network model that calculates coordinates and scores for each class of the object area candidates by using the plurality of feature maps having various sizes, and designates the class of the object based on the score for each class to generate the first object detection result data.

Meanwhile, the second neural network model 300 may be pre-learned based on a predetermined second loss function. The second loss function may be a criterion for determining the similarity degree between the prediction value and the actual value. The second loss function may include at least one of the mean squared error, the mean absolute error, and/or the root mean square error. The second loss function may include multibox-loss.

The second loss function may be expressed by Equation 2 below.

$$L ( x , c , l , g ) = \frac{1}{N} ( {L}_{conf} ( x , c ) + α {L}_{loc} ( x , l , g ) ) \qquad [ Equation 2 ]$$

Here, L_{conf} is an equation of calculating a class loss value for a class of an object based on the first object detection result data generated through the second neural network model 300 and an actual class based on prestored ground-truth, and L_{loc} is an equation of calculating a location loss value for a location of an object based on the first object detection result data and an actual location based on the prestored ground-truth.

Referring back to FIG. 3, the first noise generation unit 400 may generate first noise based on a first loss value between the first object detection result data and the prestored ground-truth (ground-truth).

The first noise generation unit 400 may calculate the first loss value between the first object detection result data and the prestored ground-truth based on the predetermined first loss function. The first noise generation unit 400 may generate the first noise based on the calculated first loss value.

The first adversarial image generation unit 500 may generate the first adversarial image based on the first noise and the first conversion image. The first adversarial image generation unit 500 may generate the first adversarial image by adding the first noise to at least one first conversion image pixel constituting the first conversion image. That is, the first adversarial image may be an image generated by adding the first noise to at least one first conversion image pixel constituting the first conversion image once or more.

The first adversarial image generation unit 500 may include projected gradient descent (PGD). The PGD may be expressed by Equation 3 below.

x^{t+1}=π_{x+S}(x^{t}+α sgn(∇ₓL(θ,x,y))) [Equation 3]

Here, x^{t} may represent the first adversarial image generated by adding the first noise t times, ∇ₓL(θ,x,y) may represent the first noise, and θ may represent a parameter of the first loss function. Specifically, ∇ₓL(θ,x,y) may means the first noise which is a slope of x calculated by backpropagating a difference between the first object detection result data and the prestored ground-truth. α may represent a parameter for setting the strength of noise.

The second noise generation unit 600 may generate second noise based on a second loss value between the first adversarial image and the first conversion image.

The second noise generation unit 600 may calculate the second loss value between the first adversarial image and the first conversion image based on a predetermined second loss function. In addition, the second noise generation unit 600 may generate the second noise based on the calculated second loss value.

The second adversarial image generation unit 700 may generate a second adversarial image based on the second noise and the original image. The second adversarial image generation unit 700 may generate the second adversarial image by adding the second noise to at least one original image pixel constituting the original image. That is, the second adversarial image may be an image generated by adding the second noise to at least one original image pixel constituting the original image once or more.

The second adversarial image generation unit 700 may include Iterative Fast Gradient Signed Method (I_FGSM). The I_FGSM as a function of repeatedly performing the FGSM, and in other words, a function in which the maximum repetition number of times of the I_FGSM is 1 may be the same as the FGSM. The I_FGSM has large time consumption, but may show a better attack effect than the general FGSM.

The FGSM may be a technique that generates an adversarial sample by using a gradient of the neural network. If the input of the model is the image, the gradient of the loss function for the input image is calculated to generate an adversarial image that maximizes the loss.

The I_FGSM may be expressed by Equation 4 below.

X₀^{adv}=X, X_{N+1}^{adv}=Claip_{X,ϵ}{Xₙ^{adv}+α sign(∇_{X}J(X_{N}^{adv},yₜᵣᵤₑ))} [Equation 4]

Here, X_{N}^{adv} means an image generated by adding noise N times and in the case of N=0, i.e., X₀^{adv} means the original image to which the noise is not added. yₜᵣᵤₑ means a ground-truth, and in the embodiment, may be the first adversarial image. A sign function is a sign function. Clip_{X,ϵ} may serve to prevent the noise from being viewed by an eye of the person by clipping a value in parentheses not to depart from a range between X+ε and X−ε. α may represent the parameter for setting the strength of the noise.

The third neural network model 800 may be a model in which a second super resolution model of generating the second conversion image configured with a higher resolution than the second adversarial image based on the second adversarial image and a second object detection model of detecting at least one object in the second conversion image, and designating the location and the class of at least one detected object to generate second object detection result data are combined.

Specifically, the third neural network model 800 may include the second super resolution model including at least one of the SRCNN, the RCAN, and/or the DBPN. Here, the SRCNN may be a neural network model constituted by a plurality of layers (e.g., three layers). The SRCNN may be a neural network model that downsamples the second adversarial image by the bicubic scheme in the preprocessing step to generate the low-resolution image. In addition, the SRCNN may be previously learned by a scheme of learning a feature between an image which is not clear generated from the low-resolution image and the second adversarial image. The SRCNN may be a neural network model that generates the second conversion image configured with a higher resolution than the second adversarial image by using the input second adversarial image.

The RCAN may be a neural network model that extracts feature information of the second adversarial image through the convolutional layer. In addition, the RCAN may be a neural network model that extracts deep feature information from the feature information through a channel attention module to generate the second conversion image which is the high-resolution image.

The DBPN may be a neural network model that extracts a feature map by inputting the second adversarial image into the convolutional layers, and inputs the feature map into a module in which an up-block and a down-block are repeatedly configured. The up-block may be a block that enlarges the feature map. The down-block may be a block that reduces the feature map. An error of each of the up-block and the down-block repeatedly configured is calculated to deliver a feedback to the network. In addition, the DBPN may be a neural network model that concatenates enlarged respective feature maps generated in the up-blocks, respectively. The DBPN may be a neural network model that generates the second conversion image which is the high-resolution image by inputting the concatenated enlarged feature map into the convolutional layer.

Meanwhile, the third neural network model 800 may include the second object detection model including at least one of the YOLO, the Faster R-CNN, and/or the SSD.

Here, the YOLO may be an algorithm that divides the second conversion image into a plurality of grids having the same size. The YOLO may be an algorithm that predicts the number of bounding boxes designed in a predefined form around a grid center for each of the plurality of grids. The YOLO may be an algorithm that calculates the reliability based on the number of bounding boxes, and selects a location having a high object reliability by considering whether the object is included in the image and identifies the object. The YOLO may be an algorithm that designates the class of the identified object to generate the second object detection result data.

The Faster R-CNN may be a neural network model that extracts the feature map from the second conversion image through the CNN, and generates object area candidates through the feature map by using Region Proposal Net (RPN). The Faster R-CNN may be a neural network model that calculates coordinates and scores of the object area candidates, and designates the class of the object based on the score to generate the second object detection result data.

The SSD may be a neural network model that extracts the feature map from the second conversion image through the CNN. The SSD may be a neural network model that extracts a plurality of feature maps having various sizes by using a plurality of different convolutional layers. The SSD may be a neural network model that calculates coordinates and scores for each class of the object area candidates by using the plurality of feature maps having various sizes, and designates the class of the object based on the score for each class to generate the second object detection result data.

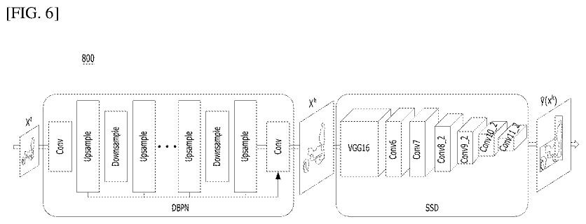

Meanwhile, the third neural network model 800 according to some exemplary embodiments of the present disclosure will be described below with reference to FIG. 6. FIG. 6 is a diagram for describing a third neural network model 800 according to some exemplary embodiments of the present disclosure.

Referring to FIG. 6, the third neural network model 800 may be a model in which the second super resolution model including the DBPN and the second object detection model including the SSD are combined. Therefore, the third neural network model 800 may generate the second conversion image X^{h} which is the high-resolution image by inputting the second adversarial image X^{l} into the second super resolution model including the DBPN. In addition, the third neural network model 800 may generate the second object detection result data ŷ(X^{h}) by inputting the generated second conversion image X^{h} into the second object detection model including the SSD.

The second adversarial image may be input into the third neural network model 800, and the performance of the third neural network model 800 may be determined through the second adversarial image. The third neural network model 800 may generate the second object detection result data based on the second adversarial image.

Meanwhile, the processor 110 may determine the performance of the third neural network model 800 based on a third loss value between the second object detection result data and the prestored ground-truth. The processor 110 may determine the performance the third neural network model 800 by comparing the third loss value and a predetermined threshold. For example, the processor 110 may determine that the performance the third neural network model 800 is low and determine that the performance is less than a criterion when the third loss value is larger than the predetermined threshold. However, the method in which the processor 110 is determines the performance of the third neural network model 800 is not limited thereto, and the processor 110 may determine the performance of the third neural network model 800 through various methods.

Here, according to some exemplary embodiments of the present disclosure, the third neural network model may be present in an external device. Therefore, the processor 110 may deliver the second adversarial image to the external device through the network unit 150. The external device inputs the second adversarial image received by the third neural network model to determine the performance of the third neural network model and complement the third neural network model.

Meanwhile, according to some exemplary embodiments of the present disclosure, the first neural network model 200 and the second neural network model 300 are also be coupled to each other to constitute one neural network model. Therefore, one model is configured in which the first neural network model 200 and the second neural network model 300 are coupled to each other to have a similar structure to the third neural network model 800.

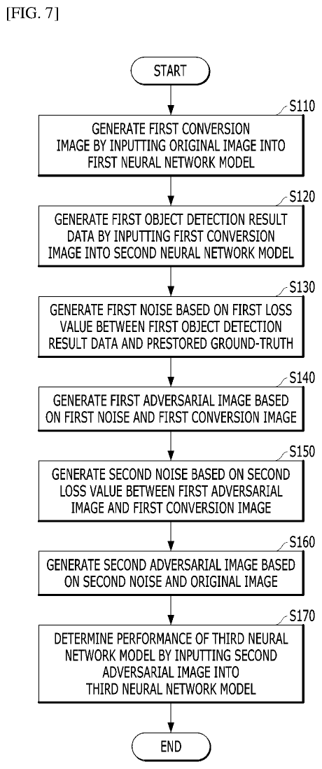

FIG. 7 is a flowchart for describing the method for performing an adversarial attack performed by the computing device according to some exemplary embodiments of the present disclosure.

Referring to FIG. 7, the processor 110 of the computing device 100 may generate the first conversion image by inputting the original image into the first neural network model 200 (S110).

Here, the first neural network model 200 may include a first super resolution model that generates the first conversion image configured with a higher resolution than the original image based on the original image.

The first neural network model 200 may be pre-learned based on a predetermined first loss function.

The processor 110 may generate the first object detection result data by inputting the first conversion image into the second neural network model 300 (S120).

Here, the second neural network model 300 may include a first object detection model that detects at least one object in the first conversion image, and designates a location and a class of at least one object, and generates the first object detection result data.

The processor 110 may generate first noise based on a first loss value between the first object detection result data and a prestored ground-truth (S130).

The processor 110 may calculate the first loss value between the first object detection result data and the prestored ground-truth based on the predetermined first loss function. The processor 110 may generate the first noise based on the calculated first loss value.

The processor 110 may generate the first adversarial image based on the first noise and the first conversion image (S140).

The processor 110 may generate the first adversarial image by adding the first noise to at least one first conversion image pixel constituting the first conversion image.

The processor 110 may generate second noise based on a second loss value between the first adversarial image and the first conversion image (S150).

The processor 110 may calculate the second loss value between the first adversarial image and the first conversion image based on a predetermined second loss function. The processor 110 may generate the second noise based on the calculated second loss value.

The processor 110 may generate the second adversarial image based on the second noise and the original image (S160).

The processor 110 may generate the second adversarial image by adding the second noise to at least one original image pixel constituting the original image.

The processor 110 may determine the performance of the third neural network model 800 by inputting the second adversarial image into the third neural network model 800 (S170).

The processor 110 may generate the second object detection result data by inputting the second adversarial image into the third neural network model. The processor 110 may determine the performance of the third neural network model based on a third loss value between the second object detection result data and the prestored ground-truth.

Here, the third neural network model 800 may be a model in which a second super resolution model of generating the second conversion image configured with a higher resolution than the second adversarial image based on the second adversarial image and a second object detection model of detecting at least one object in the second conversion image and designating the location and the class of at least one detected object to generate second object detection result data are combined.

The steps illustrated in FIG. 7 are exemplary steps. Therefore, it is also apparent that some of the steps of FIG. 7 may be omitted or additional steps may be present in the limit that does not depart from the scope of the idea of the spirit of the present disclosure.

Specific contents regarding the components 100 to 800 and each step disclosed in FIG. 7 may be replaced with the contents described through FIGS. 1 to 6 above.

Meanwhile, one example among the methods for generating the adversarial image by the computing device 100 will be described below with reference to FIGS. 1 to 7.

### EXAMPLE

The processor 110 of the computing device 100 designated an image having a resolution of 75*75 as the original image.

Step 1: The processor 110 generated the first conversion image having a resolution of 300*300 which increases four times in resolution by inputting the original image into the first neutral network model 200 including the DBPN.

Step 2: The processor 110 generated the first object detection result data by inputting the first conversion image into the second neural network model 300 including the SSD and calculated the first loss value between the first object detection result data and the prestored ground-truth by using the second loss function.

Step 3: The processor 110 calculated the slope of the first conversion image by backpropagating the first loss value.

Step 4: The processor 110 substituted the slope of the first conversion image into part ∇ₓL(θ,x,y) in Equation 3 described above and calculated a sign of the first noise through the sign function.

Step 5: The processor 110 multiplied the sign of the first noise by α which is a noise strength value.

Step 6: The processor 110 added the value calculated in step 5 to the first conversion image.

Step 7: The processor 110 subtracted the first conversion image from the value calculated in step 6.

Step 8: The processor 110 calculated the first noise by clipping the value calculated in step 7 between ±ε.

Step 9: The processor 110 calculated a primary first adversarial image in which the noise is generated repeatedly once by adding the first noise to the first conversion image.

Step 10: The processor 110 repeated steps 2 to 9, and substituted the first conversion image in steps 2, 3, and 6 with the primary first adversarial image. The processor 110 repeated this at the maximum number of repetition times, and substituted the primary first adversarial image with a secondary first adversarial image in a next repetition.

That is, the processor 110 repeated steps 2 to 9 by substituting an (N−1)th first adversarial image with an Nth first adversarial image, and decided the Nth first adversarial image generated after finally repeating the steps N times which is the maximum number of repetition times as a final first adversarial image, i.e., the first adversarial image according to the present disclosure.

Step 11: The processor 110 calculated the second loss value between the first conversion image and the first adversarial image by using the first loss function.

Step 12: The processor 110 calculated the slope of the original image by backpropagating the second loss value.

Step 13: The processor 110 substituted the slope of the original image into part ∇_{X}J(X_{N}^{adv},yₜᵣᵤₑ) in Equation 4 and calculated the sign of the second noise.

Step 14: The processor 110 multiplied the second noise sign by a value acquired by dividing α by N which is the maximum number of repetition times.

Step 15: The processor 110 calculated the second noise by clipping the value calculated in step 14 between ±ε.

Step 16: The processor 110 added the second noise to the original image, and clipped this between 0 and 1 to calculate a primary second adversarial image.

Step 17: The processor 110 repeated steps 11 to 16, and substituted the first conversion image in step 11 with a primary second converted adversarial image acquired by making the primary second adversarial image with a super-resolution, and substituted the original images in steps 12 and 16 with the primary second adversarial image.

That is, the processor 110 repeated steps 11 to 16 by substituting an (N−1)th second adversarial image with an Nth second adversarial image, and decided the Nth second adversarial image generated after finally repeating the steps N times which is the maximum number of repetition times as a final second adversarial image, i.e., the second adversarial image according to the present disclosure.

Therefore, the processor 110 may generate the second adversarial image to include both noise generated by using the first loss function used for learning of the first neural network model including a super-resolution model and noise generated by using the second loss function used for learning of the second neural network model including an object detection model. That is, the processor 110 may generate the second adversarial image that may perform the attack for both the super-resolution model and the object detection model.

The processor 110 ma perform an adversarial attack for malfunctioning an object detection model with a super resolution by using the second adversarial image.

As described above, according to an exemplary embodiment of the present disclosure, unlike an individual attack of performing an attack against only one conventional model, an attack against two models is performed to achieve a high performance According to an exemplary embodiment of the present disclosure, the adversarial attack against the object detection model with the super resolution is performed to measure robustness by evaluating the model. According to an exemplary embodiment of the present disclosure, a vision of a research into a defense method of a computer vision model can be expanded.

The adversarial attack is performed for a specific model, and a defense technique therefor also shows an excellent defense performance only for a specific adversarial attack. However, when an individual defense method is configured only for one model in an environment in which two models are combined and used, a defense performance deteriorates for the adversarial image that attacks both the models. Therefore, according to the technique according to an exemplary embodiment of the present disclosure, it may be possible to generate the adversarial image that may attack both the models for evaluating both models in the environment in which two models are combined and used.

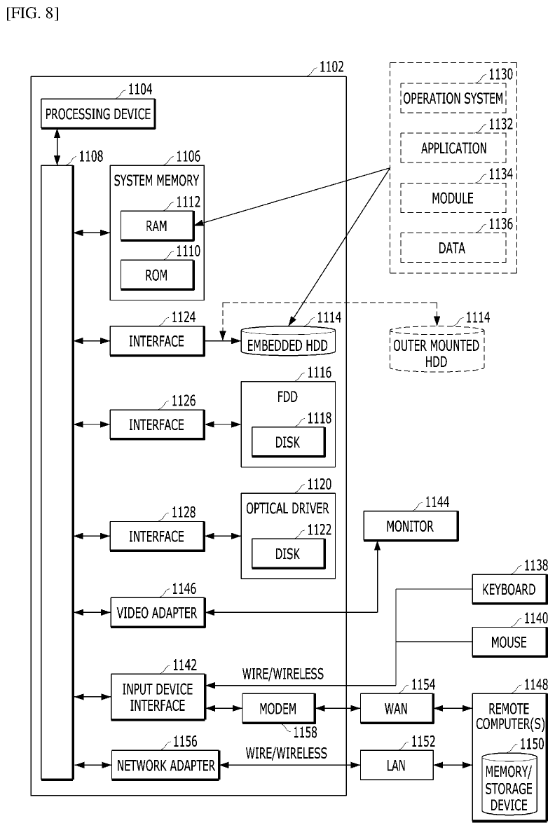

FIG. 8 illustrates a simple and general schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for performing an adversarial attack by a computing device including one or more processors, the method comprising:
generating a first conversion image by inputting an original image into a first neural network model;
generating first object detection result data by inputting the first conversion image into a second neural network model;
generating first noise based on a first loss value between the first object detection result data and a prestored ground-truth;
generating a first adversarial image based on the first noise and the first conversion image;
generating second noise based on a second loss value between the first adversarial image and the first conversion image; and
generating a second adversarial image based on the second noise and the original image.

2. The method of claim 1, wherein the first neural network model includes a first super resolution model that generates the first conversion image configured with a higher resolution than the original image based on the original image.

3. The method of claim 1, wherein the second neural network model includes a first object detection model that detects at least one object in the first conversion image, and designates a location and a class of at least one object, and generates the first object detection result data.

4. The method of claim 1, wherein the first neural network model is pre-learned based on a predetermined first loss function, and
the generating of the first noise based on the first loss value between the first object detection result data and the prestored ground-truth includes
calculating the first loss value between the first object detection result data and the prestored ground-truth based on the predetermined first loss function, and
generating the first noise based on the calculated first loss value.

5. The method of claim 1, wherein the second neural network model is pre-learned based on a predetermined second loss function, and
the generating of the second noise based on the second loss value between the first adversarial image and the first conversion image includes
calculating the second loss value between the first adversarial image and the first conversion image based on the predetermined second loss function, and
generating the second noise based on the calculated second loss value.

6. The method of claim 1, wherein the generating of the first adversarial image based on the first noise and the first conversion image includes
generating the first adversarial image by adding the first noise to at least one first conversion image pixel constituting the first conversion image.

7. The method of claim 1, wherein the generating of the second adversarial image based on the second noise and the original image includes
generating the second adversarial image by adding the second noise to at least one original image pixel constituting the original image.

8. The method of claim 1, further comprising:
determining a performance of the third neural network model by inputting the second adversarial image into a third neural network model.

9. The method of claim 8, wherein the determining of the performance of the third neural network model by inputting the second adversarial image into the third neural network model includes
generating second object detection result data by inputting the second adversarial image into the third neural network model, and
determining the performance of the third neural network model based on a third loss value between the second object detection result data and the prestored ground-truth.

10. The method of claim 9, wherein the third neural network model is a model in which a second super resolution model of generating a second conversion image configured with a higher resolution than the second adversarial image based on the second adversarial image and a second object detection model of detecting at least one object in the second conversion image and designating a location and a class of at least one detected object to generate the second object detection result data are combined.

11. A non-transitory computer readable medium storing a computer program, wherein the computer program comprises instructions for causing a processor of a computing device for performing an adversarial attack to perform the following steps, the steps comprising:
generating a first conversion image by inputting an original image into a first neural network model;
generating first object detection result data by inputting the first conversion image into a second neural network model;
generating first noise based on a first loss value between the first object detection result data and a prestored ground-truth;
generating a first adversarial image based on the first noise and the first conversion image;
generating second noise based on a second loss value between the first adversarial image and the first conversion image; and
generating a second adversarial image based on the second noise and the original image.

12. A computing device for performing an adversarial attack, comprising:
a processor;
a memory storing a computer program executable in the processor; and
a network unit,
wherein the processor is configured to
generate a first conversion image by inputting an original image into a first neural network model,
generate first object detection result data by inputting the first conversion image into a second neural network model,
generate first noise based on a first loss value between the first object detection result data and a prestored ground-truth,
generate a first adversarial image based on the first noise and the first conversion image,
generate second noise based on a second loss value between the first adversarial image and the first conversion image, and
generate a second adversarial image based on the second noise and the original image.
